(19) United States
(12) Patent Application Publication
(10) Pub. No.: US 2002/0163443 A1
(43) Pub. Date: Nov. 7, 2002

(54) Airport valet communication system

(75) Inventors: Gregory M. Stewart, Tacoma, WA (US); David G. Baur, Albuquerque, NM (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: IDmicro, Inc.

(21) Appl. No.: 09/997,283

(22) Filed: Nov. 29, 2001

Related U.S. Application Data
(63) Continuation-in-part of application No. 09/653,515, filed on Aug. 31, 2000.
(60) Provisional application No. 60/253,818, filed on Nov. 29, 2000.
(60) Provisional application No. 60/152,511, filed on Sep. 2, 1999.

(51) Int. Cl. G08G 1/14

(52) U.S. Cl. 340/932.2; 340/572.1; 340/539; 340/686.6; 340/825.49; 340/988

(57) ABSTRACT

An improved airport valet communication system is presented. The system attaches a vehicle tag to a vehicle. A stall tag is also provided and is placed somewhere within the vicinity of a parking stall. To communicate with these two tags, a handheld computer is provided by the system for communicating with the vehicle tag via radio frequency communication to obtain an identification of the vehicle and for communicating with the stall tag via radio frequency communication to obtain an identification of the parking stall so as to correlate the vehicle and the parking stall in which the vehicle is parked.

### CROSS-REFERENCE TO RELATED APPLICATIONS

This application claims the benefit of U.S. Provisional Application No. 60/253,818, filed Nov. 29, 2000, which is expressly incorporated herein by reference. This application is also a continuation-in-part of U.S. application Ser. No. 09/653,515, filed Aug. 31, 2000, which is based on U.S. Provisional Application No. 60/152,511, filed Sep. 2, 1999.

### FIELD OF THE INVENTION

This invention generally relates to the field of transportation systems and, more specifically, relates to an airport valet communication system.

### BACKGROUND OF THE INVENTION

Many modern airports have perimeter parking lots where passengers park their vehicles while they travel to a remote destination and return. Many such parking lots are operated by commercial organizations, such as car rental and travel companies. The parking lots usually provide courtesy vans, or buses, for carrying customers from the perimeter parking lot to the airport, and from the airport to the perimeter parking lot.

Some of these parking lots offer valet services for those customers who appreciate the freedom of leaving their cars in the care of another so as to leave more time to catch a flight or attend to other trip errands. However, typically, not only must a customer leave his car but he must also fill out numerous forms or give identifying information to the attendant so that a paper ticket may be issued and the customer can commence his trip. Then, the attendant proceeds to park the car and fills out additional paperwork to relate the location of the parked car and the identifying information of the customer. Numerous things can go wrong with these prior valet services. For example, if more than a few customers require the attention of the attendant, those customers not near the top of the queue may have to wait a frustratingly long period of time, which may result in missing flights. As another example, the papers, such as tickets being held by customers, are easily lost. Although the common goal of these valet services is to free the customers to gain more time, more often it seems these services burden customers instead.

Another problem occurs when customers return from their trip. Transporting customers from the perimeter parking lot to the airport is relatively easy, because customers will congregate at the parking lot reception area located at the perimeter parking lot after parking their cars. However, knowing when to send a bus to pick a customer up at the airport and deliver them to the perimeter parking lot is considerably more difficult. Previous systems and methods for determining when to pick a customer up at the airport have required customers to call the parking lot reception area to request a courtesy pick-up after they have arrived and collected their luggage. However, these systems require customers to transport their luggage to a telephone, make a telephone call, and wait for the courtesy bus to arrive. This process can be extremely burdensome and inconvenient for a customer. Accordingly, in light of these problems, there is a need for an airport valet communication system that can reduce the complexity of current parking lot notification systems and increase customer convenience.

### SUMMARY OF THE INVENTION

The present invention solves the above-described problems by providing a customer tag for a customer, a vehicle tag for the vehicle of the customer, and a stall tag for the parking stall in which the vehicle of the customer is parked. Each of these tags may be communicated via a short-range radio frequency so that the identifying information on these tags may be acquired.

After the customer has dropped off his vehicle to the attendant, the customer may immediately commence his trip without having to fill out forms or physically leave any identifying information. The main computer at the valet service communicates with the customer tag to obtain the identity of the customer who is leaving the car with the service. Prior to parking the vehicle, the attendant, using a handheld computer, communicates with the vehicle tag to obtain the identity of the vehicle, and subsequent to parking the vehicle at a parking stall, the attendant communicates with the stall tag at the parking stall so as to obtain the identity of the parking stall in which the vehicle is parked. These pieces of identifying information are then downloaded to the main computer so that the main computer can correlate the customer with the vehicle and the location of the vehicle in the parking lot. The main computer may form a trip record that contains the identity of the customer, the departure date of the customer, the vehicle, and the parking stall in which the vehicle is parked.

When the customer returns from his trip, he proceeds to a communication island so that his customer tag may be interrogated by the computers on the communication island. Upon obtaining the identity of the customer, the communication island communicates with the main computer so that the main computer can look up in the database and display on a screen the customer's name, departure date, vehicle license number, and the parking stall in which the vehicle of the customer is parked. A valet is dispatched to pick up the customer and bring him back to the lot of the valet service. In the mean time, the attendant retrieves the vehicle from the parking stall and readies the vehicle for the customer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram illustrating an actual operating environment for aspects of the present invention.

FIG. 2 is a block diagram showing an RFID tag and an RFID encoder utilized in an embodiment of the present invention.

FIG. 3 is a block diagram showing further aspects of an actual operating environment for the present invention.

FIG. 4 is a block diagram showing an illustrative installation of an interrogator, a computer, antennas, and a display in the illustrative operating environment.

FIG. 5 is a block diagram illustrating the architecture of an RFID interrogator and computer utilized in an actual embodiment of the present invention.

FIG. 6 is a block diagram illustrating the architecture of a base computer utilized in an embodiment of the present invention.

FIG. 7 is a flow diagram illustrating a routine for encoding a RFID tag according to an actual embodiment of the present invention.

FIGS. 8A and 8B are state diagrams illustrating the operation of a RFID interrogator and interrogator computer according to an actual embodiment of the present invention.

FIGS. 9A-9C are state diagrams illustrating the operation of a base computer according to an embodiment of the present invention.

FIG. 10 is a block diagram of a system illustrating a communicating relationship between a vehicle, a parking stall in which the vehicle is parked, a key ring holding a key to start the vehicle, a handheld computer, a main computer, a customer, and a database according to one embodiment of the present invention.

FIG. 11 is a process diagram illustrating a method for obtaining information regarding the vehicle and the parking stall in which the vehicle is parked when the customer commences upon his trip according to one embodiment of the present invention.

FIG. 12 is a process diagram illustrating a method for obtaining information regarding the customer upon returning from his trip so that his vehicle may be retrieved by an attendant according to one embodiment of the present invention.

### DETAILED DESCRIPTION OF THE PREFERRED EMBODIMENT

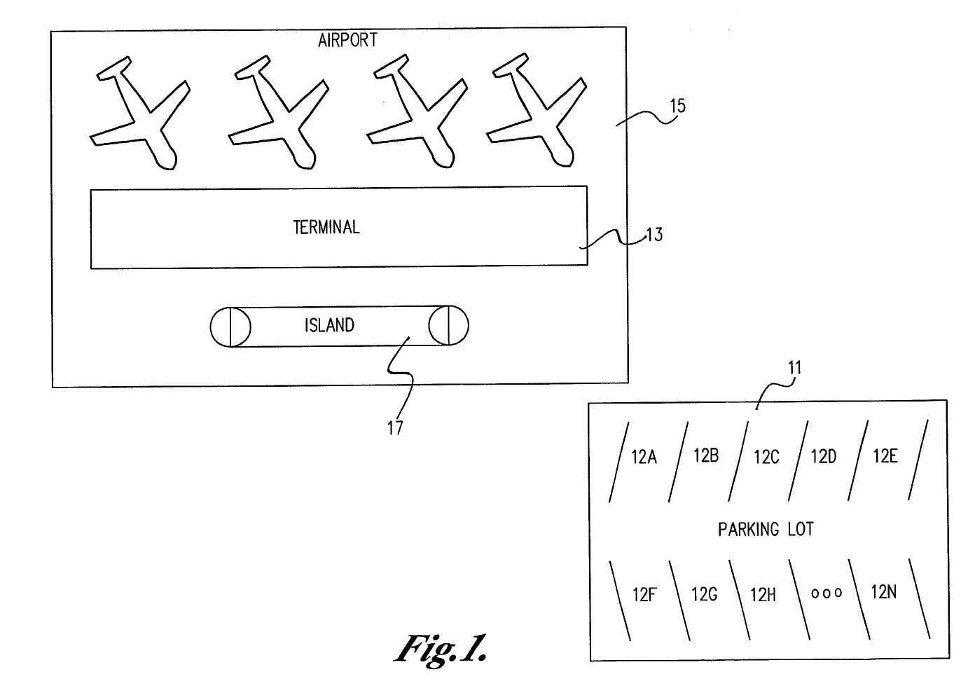

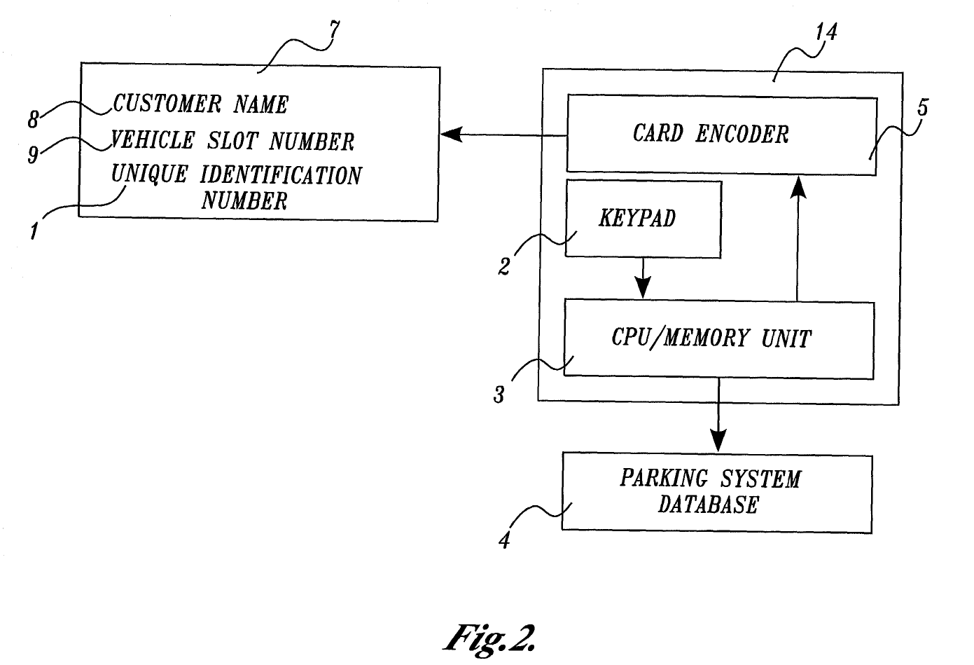

As will be better understood from the following description, the present invention provides an improved airport parking communication system. Referring now to the figures, in which like numerals represent like elements, aspects of the present invention will be described. FIG. 1 shows an illustrative operating environment for aspects of the invention. In particular, when a customer arrives at parking lot 11, the customer is issued an RFID tag. This RFID tag may also be issued at the time the customer enrolls in accordance with another embodiment so that there would not be a large queue of customers waiting to get their tags at the parking lot 11. The RFID tag contains information uniquely identifying the RFID tag. For instance, the tag may be encoded with a unique identification number 1 or may be manufactured containing a unique identification number 1. The customer's name and optionally vehicle slot number 12A-12N may also be electronically written onto the tag. This information uniquely identifying the RFID tag is then stored in a parking system database. This occurs before the customer enters a courtesy bus for the terminal 13 of the airport 15. An RFID encoder for encoding a RFID tag is described below with respect to FIG. 2.

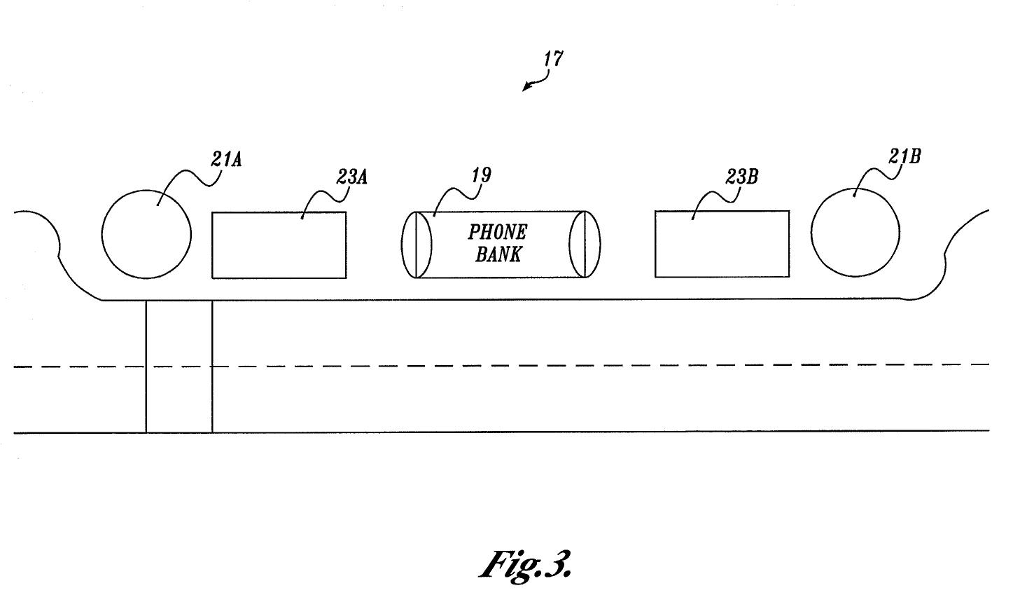

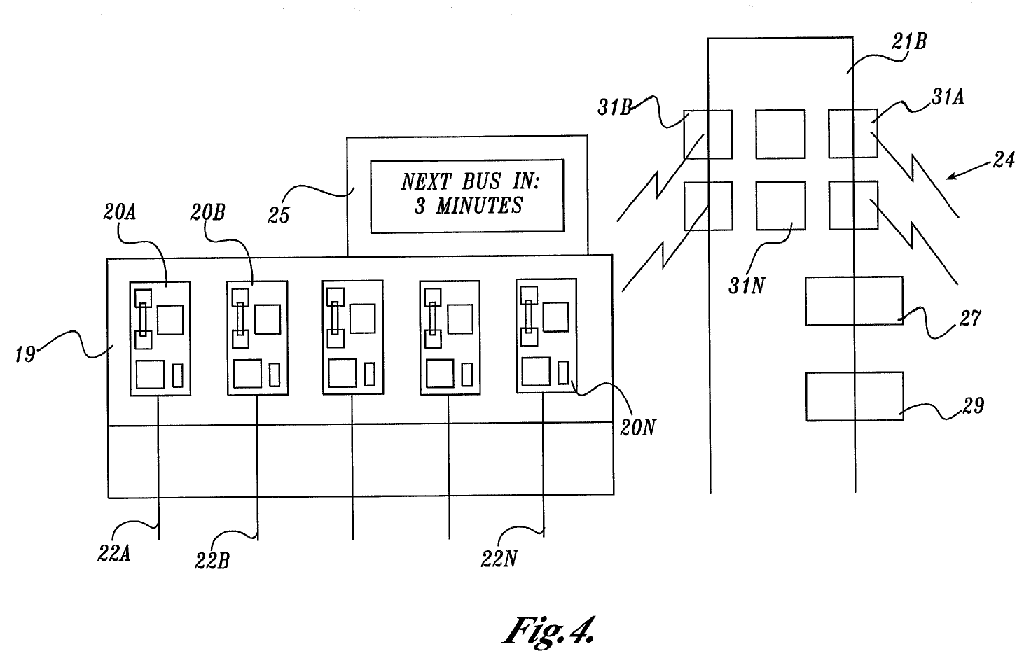

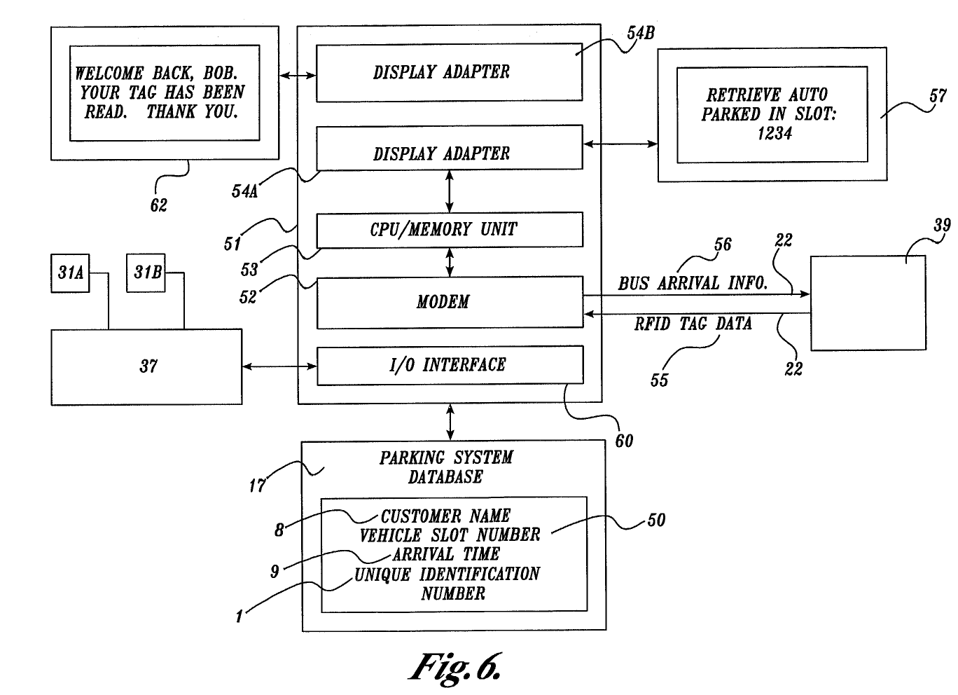

After the customer returns to the airport 15 and gathers his bag at the terminal 13, the customer proceeds to an island 17 that includes RFID interrogators that read the information stored in the RFID tag carried by the customer. An illustrative island 17 and RFID interrogator are described below with respect to FIGS. 3 and 4, respectively. The read information is transmitted to a base computer located at the parking lot 11. The information is used to dispatch a bus to pick up the customer at the island 17. The information may also be displayed to an attendant so that the attendant may retrieve the customer's car from the appropriate vehicle slot number 12A-12N, and make the vehicle ready for the customer upon arrival. The base computer may also transmit information regarding the arrival time for the next courtesy bus to the island, where it may be displayed for the customer. An illustrative base computer will be described below with reference to FIG. 6.

Referring now to FIG. 2, an illustrative RFID encoder 14 will be described. When a customer arrives at the parking lot 11, the customer provides their name and the vehicle slot number 12A-12N in which they parked their vehicle. This information is entered into the RFID encoder 14 using a keypad 2. The cpu/memory unit 3 of the RFID encoder stores this information in a parking system database 4 for later retrieval. The arrival time of the customer at the parking lot may also be stored in the parking system database 4 for use in determining the parking fees owed by the customer upon their return. The cpu/memory unit 3 also controls the operation of a card encoder 5 for encoding the customer name 8 and vehicle slot number 9 onto an RFID card 7. Encoded RFID tags can be remotely interrogated (decoded) by RFID decoders, described below. The card is then issued to the customer and the customer takes the card with them.

According to an embodiment of the invention, the RFID tag 7 may be encoded with a unique identification number 1. When the customer arrives at the parking lot, they are issued the RFID tag 7 and no additional information is encoded on the RFID tag 7. The unique identification number 1 is used to identify the customer. As known to those skilled in the art, the RFID tag 7 may come from the manufacturer with a pre-encoded unique identification number 1, or the unique identification number 1 may be written to the RFID tag 7 by the RFID encoder 14.

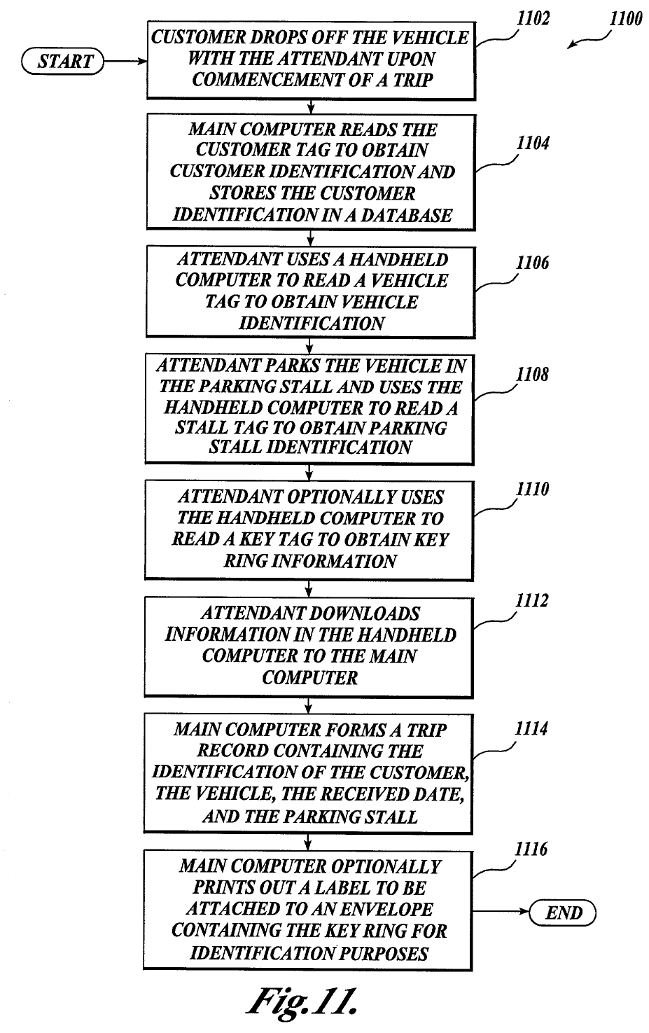

While the RFID tag 7 carried by a customer 1006 is sufficient to correlate the customer 1006 with a vehicle 1008 parked at a particular parking stall 1012, FIG. 10 illustrates a system 1000 according to another embodiment of the invention that enhances a valet parking service. After dropping off the vehicle 1008, the customer 1006 proceeds to exit the valet parking service to catch his flight or to run other errands. The base computer (main computer 1002) immediately reads the RFID tag 7 (customer tag) via radio frequency communication to obtain the identity of the customer 1006 and stores such information in the database 4. In so doing, the main computer 1002 deduces that the customer 1006 has commenced on a trip and proceeds to form a trip record, which includes the departure date of the customer 1006 to calculate fees associated with the valet parking services.

The attendant (not shown) uses a handheld computer to communicate with a vehicle tag 1010 via radio frequency communication to obtain vehicle identification. In various embodiments, the term “handheld computer” means personal digital assistants, wands, styluses, body-worn computers, body-mounted computers, or any other portable computers that are capable of communicating via radio frequency to obtain information from various tags. The vehicle tag 1010 includes various pieces of information, namely the license plate number, model, type, and color. In one embodiment, the vehicle tag 1010 is an integrated circuit having a size of a small coin. The vehicle tag 1010 can be placed anywhere on the vehicle 1008, such as the upper left comer of the inside wind shield. The installation of the vehicle tag 1010 may include the use of a Velcro sticker so as to allow easy removal of the vehicle tag 1010 according to one embodiment of the present invention.

After reading the information in the vehicle tag 1010, the attendant proceeds to park the vehicle 1008 at the parking stall 1012. Again using the handheld computer, the attendant obtains stall information from a stall tag 1014 via radio frequency communication so that the parking slot 1012 in which the vehicle 1008 is parked is identified. The stall tag 1014 can be located anywhere on the parking stall 1012, such as on the ground in the back center of the parking stall 1012.

To identify a key ring 1016 that contains a key 1018 to start the vehicle 1008, a key tag 1020 may be optionally attached to the key ring 1016. The attendant may use the handheld computer 1004 to read the identifying information from the key tag 1020. This information may be subsequently used to locate the key 1018 by identifying the key ring 1016, which may be held in a particular slot in a key box or other containers. For example, when the attendant needs to retrieve the vehicle 1008, the attendant may either visually inspect the key box or use the handheld computer 1004 to locate the location of the key 1018 so as to retrieve the vehicle 1008.

After parking the vehicle 1008, the attendant returns to the main computer 1002 and downloads various pieces of information obtained by the handheld computer 1004 to the main computer 1002. These pieces of information allow the main computer 1004 to complete the trip record for the customer 1006. The trip record may include the identity of the customer 1006, the identity of the vehicle 1008 such as the license number, the date on which the customer 1006 left the vehicle 1008 with the attendant, and the parking stall 1012 in which the vehicle 1008 is parked.

After the customer returns from their travels, the customer retrieves their luggage and proceeds to a communication island 17, as depicted in FIG. 3. The island 17 includes a bank of phones 19, columns 21A and 21B for supporting an overhead protective roof, and one or more benches 23A and 23B. As will be described in more detail below, an interrogator housing, a computer housing, and one or more antennas may be mounted on one of the columns 21B for decoding information from RFID tags located proximate to the column. Also, a display may be mounted above the bank of phones 19 for displaying information to the customer regarding the arrival time for the next bus.

As illustrated in FIG. 4, the bank of phones 19 includes one or more telephones 20A-20N connected to the public switched telephone system by way of phone lines 22A-22N. A display 25 is mounted atop the bank of phones 19. The display is connected to the computer housing 29 and displays information regarding the arrival time of the next courtesy bus, advertising, or other information. Mounted on one of the columns 21B, are one or more antennas 31B-31N. The antennas 31A-31N emit a radio frequency signal 24 that, when reflected back to the antennas 31A-31N, allow the RFID interrogator to decode the information contained in an RFID tag located within the signal range of the antennas 31A-31N. Also mounted on the column 21B is an interrogator housing 27 and a computer housing 29.

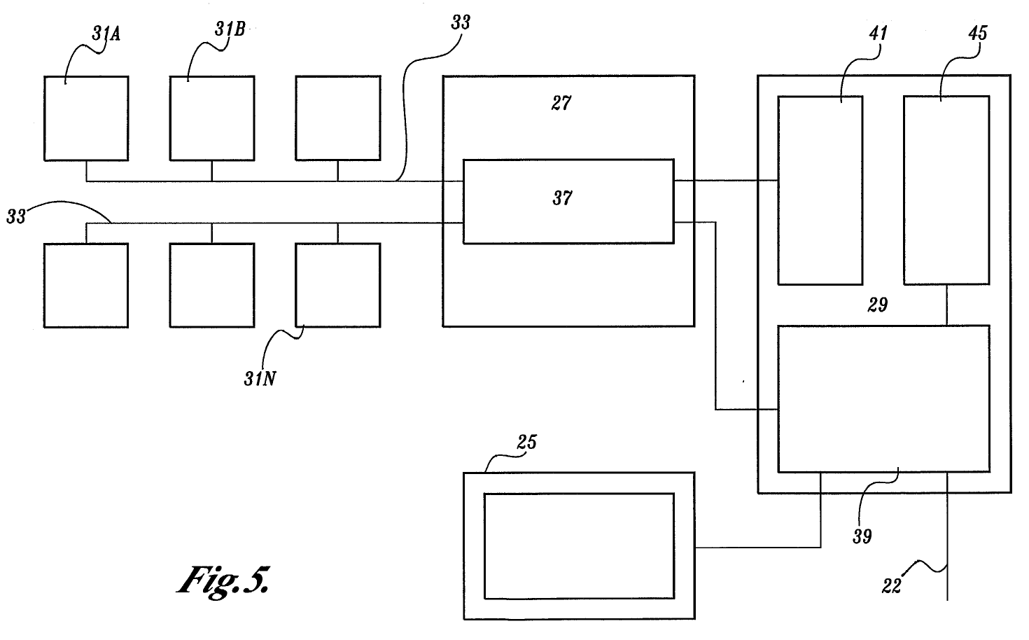

As shown in FIG. 5, the antennas 31A-31N are connected to an RFID interrogator 37 via transmission lines 33. The RFID interrogator 37 is mounted within interrogator housing 27, which is attached to one of the columns 21B. The RFID interrogator 37 is connected to a power source 41. The RFID interrogator 37 is also connected to a computer 39 mounted in the computer housing 29. The computer 39 is also connected to a power source 45, which is also located in the computer housing 29. The computer 39 is also connected to the display 25 and to a base computer located at the parking lot via the phone line 22.

In operation, the RFID interrogator 37 continuously interrogates the region surrounding the column 21B. When a customer carrying an RFID tag comes within the interrogation area, the information contained in the RFID tag is read and decoded by the RFID interrogator 37. The RFID interrogator 37 supplies the read information to the computer 39, which transmits the information to the base computer via the phone line 22. The computer 39 also causes the display 25 to display information to waiting customers regarding the waiting time for the next courtesy bus. Arrival information is supplied to the computer 39 by the base computer located at the parking lot.

It should be appreciated by those skilled in the art that multiple parking lots having multiple base computers may be utilized. In such an embodiment of the invention, RFID tag data may be broadcast to each of the base computers when the RFID tag is read and decoded by the RFID interrogator 37. Each base computer may then determine whether the information encoded on the RFID tag corresponds to an entry in their particular parking lot database. If it does not, no action will be taken. If a corresponding entry is found, the courtesy bus will be dispatched as described above. Alternatively, the RFID tag may be encoded with information identifying the particular parking lot at which a customer parked their vehicle. When the RFID tag is read, the decoded information will only be transmitted to the base computer located at the particular parking lot identified in the encoded data.

Referring now to FIG. 6, an illustrative base computer 51 will be described. The base computer 51 is located at the parking lot and comprises a cpu/memory unit 53 for controlling the operation of the base computer 51, a display adapter 54A for providing video signals to the display 57, and a modem 52 for communicating with the computer 39 via the phone line 22. The base computer 51 may also maintain a parking system database 4 on a non-volatile storage medium, for storing the customer name 8, the vehicle slot number 9, and the arrival time 50 for each customer. The base computer 51 may also comprise other conventional computing components not shown in FIG. 6.

In operation, the base computer 51 receives RFIG tag data 55 from the computer 39. When RFID tag data 55 is received, the base computer 51 retrieves the relevant data from the parking system database 4. The base computer 51 then displays the name of the customer, the departure date, the vehicle license plate, and the vehicle slot number 9 on the display 57 so that an attendant may retrieve the customer's vehicle from the appropriate slot and make the vehicle ready for the customer's arrival. The base computer 51 may also provide an alert to a dispatcher so that a courtesy bus may be sent to retrieve the customer. Alternatively, a communication may be made to a courtesy bus already en route to notify the bus that the customer should be picked up. Additionally, the base computer 51 transmits bus arrival information 56 to the computer 39. As described above, this bus arrival information is displayed for the benefit of the customer by the computer 39.

According to an embodiment of the present invention, the base computer 51 also includes an I/O interface 60 for communicating with an attached RFID interrogator 37. The RFID interrogator 37 is connected to antennas 31A-31B which are mounted proximate to the entrance to the parking lot. When a customer that was previously issued a RFID tag returns to the parking lot in their vehicle, the RFID interrogator 37 reads the information from the customer's RFID tag as they enter the parking lot. The parking system database 17 is then updated to indicate that the customer has arrived. The base computer 51 may also include a display adapter 54B for controlling display 62. The display 62 may also be mounted proximate to the entrance to the parking lot and utilized to provide an indication to the customer when they arrive that their RFID tag has been correctly read.

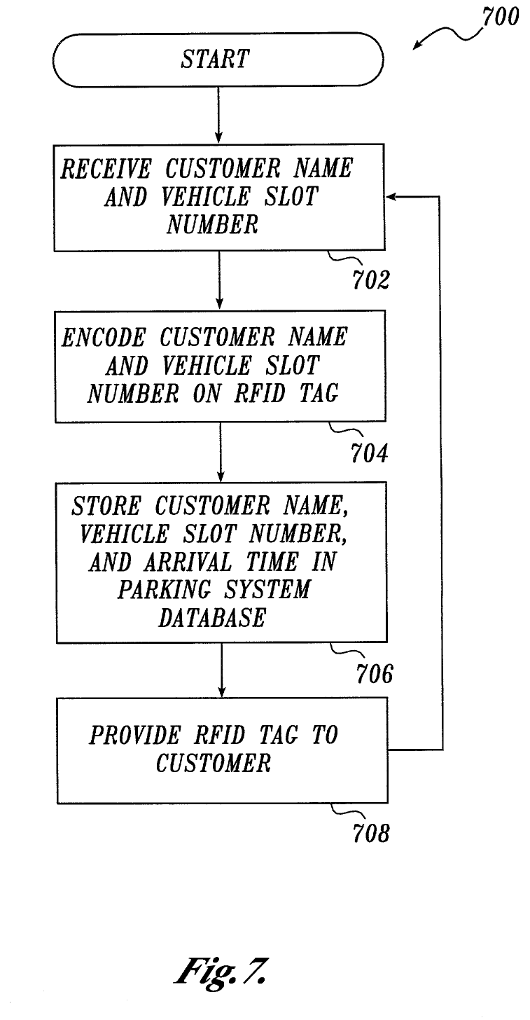

Referring now to FIG. 7, an illustrative Routine 700 will be described for encoding an RFID tag with information uniquely identifying a customer. Routine 700 begins at block 702, where the customer name and vehicle slot number are received. This information may be provided by an attendant or by the customer. Routine 700 then continues from block 702 to block 704, where the customer's name and vehicle slot number are encoded on an RFID tag. Additional information may also be encoded on the RFID tag, such as the date and time of arrival of the customer, automobile make and model, and other such information. Alternatively, a unique identification number may be written to the RFID tag or, if the RFID tag was manufactured with a unique identification number, this number may be read from the RFID tag and stored in the parking system database. From block 704, the Routine 700 continues to block 706.

At block 706, the information uniquely identifying the customer are stored in the parking system database. According to an embodiment, the customer name, vehicle slot number, and arrival time are stored in the parking system database. Alternatively, the unique identification number may be stored in the parking system database as described above. As also described above, additional information may also be stored in the parking system database as known to those skilled in the art, such as the vehicle make, model, and color, license tag number, etc. Routine 700 then continues from block 706 to block 708, where the RFID tag is provided to the customer. The customer is instructed to keep the RFID tag in a safe place and to have it available when they return to the airport. According to an embodiment of the present invention, the customer is issued the RFID tag only once. The Routine 700 then returns to block 702, where the next RFID tag is encoded.

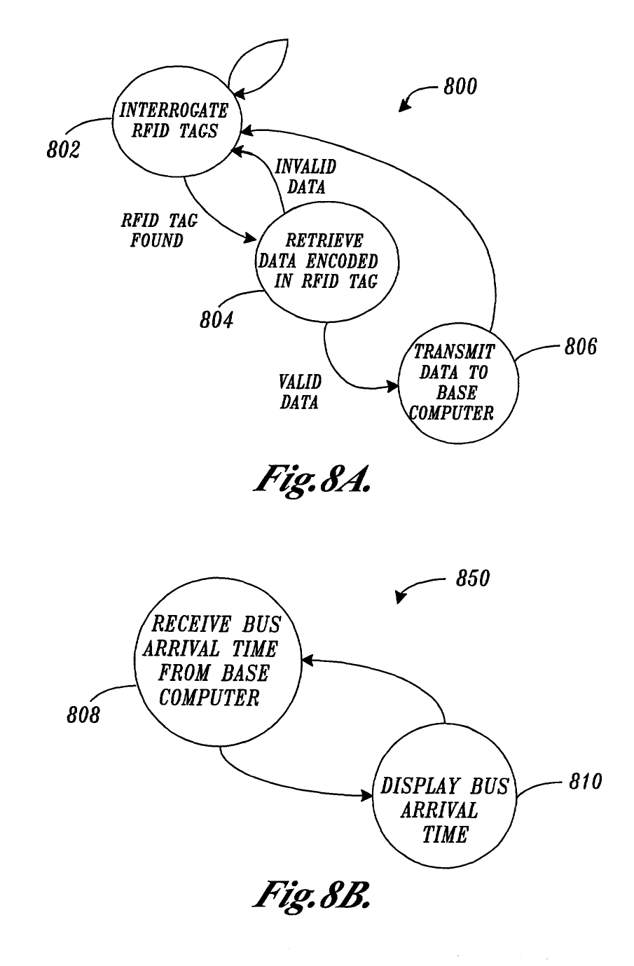

Referring now to FIGS. 8A and 8B, state diagrams 800 and 850 illustrating the operation of an illustrative RFID interrogator and a connected computer will be described. State diagram 800 begins at state 802, where the RFID interrogator continually interrogates RFID tags. If an RFID tag is found, the state diagram 800 moves from state 802 to state 804, where the data encoded in the RFID tag is retrieved and decoded. If the data is invalid, the state diagram returns to state 802 from state 804, and continues to decode RFID tags. If the data is valid, the state diagram moves from state 804 to state 806, where the RFID tag data is transmitted to the base computer located at the parking lot. Those skilled in the art should appreciate that most of the communication between the RFID interrogators and RFID tags is not reported by the interrogator to the local computer since most of the information is data sent to ensure that both the interrogator and the tag are present and functional. The state diagram then returns to state 802, where the RFID interrogator continues to interrogate RFID tags.

State diagram 850 begins at state 808, where bus arrival information is received at the interrogator computer from the base computer. When such information is received, the state changes from state 808 to 810. At state 810, the computer displays the bus arrival information on the display. As mentioned above, other types of information such as advertising may also be displayed by the computer.

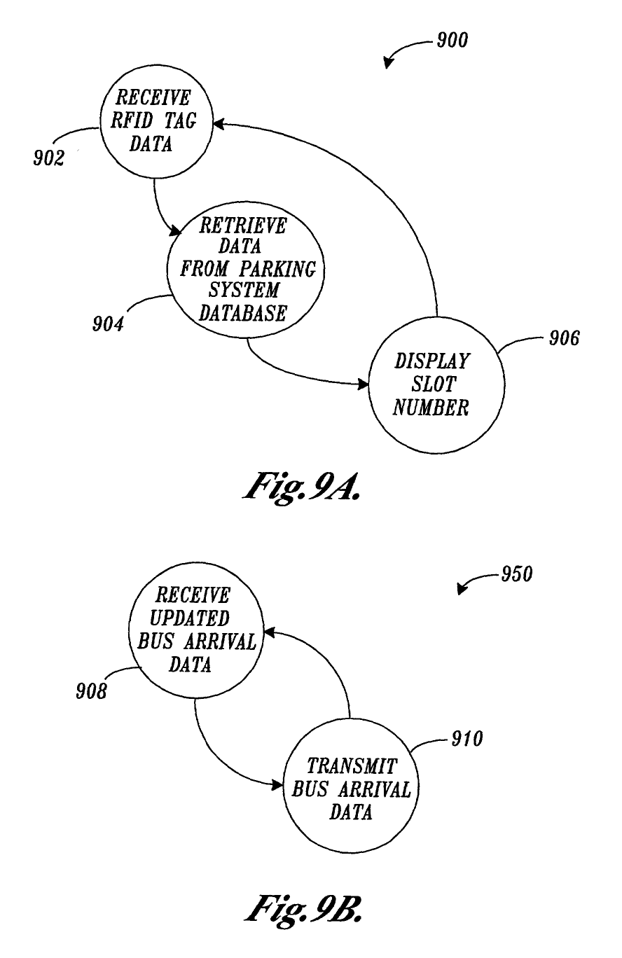

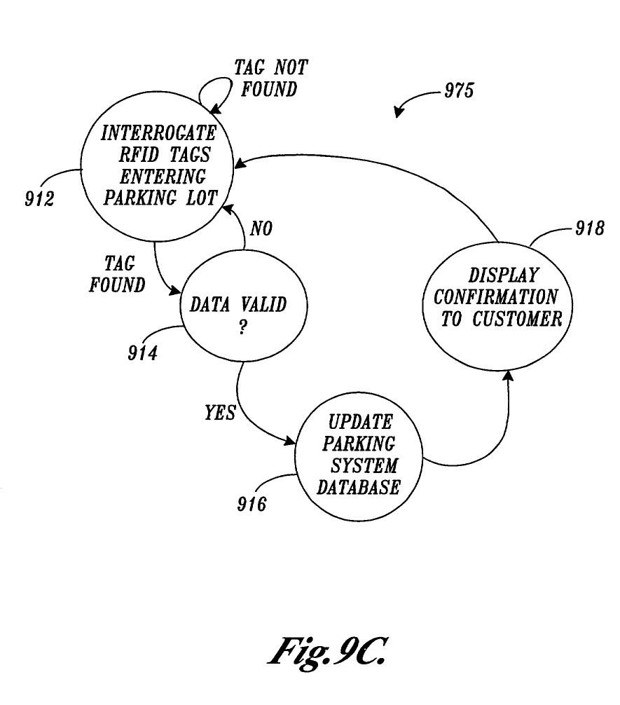

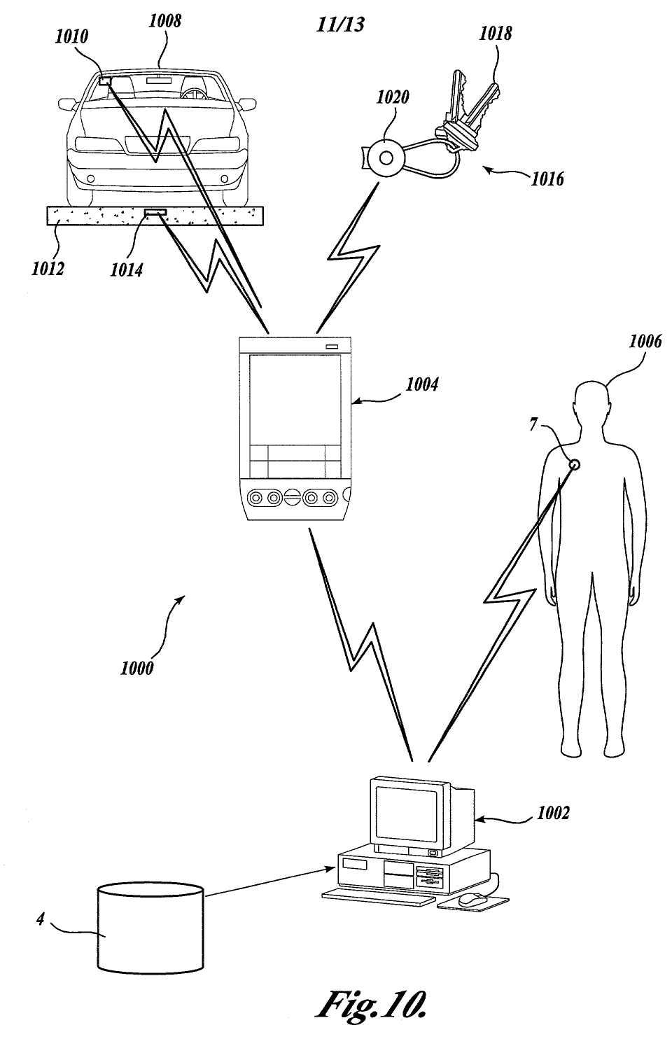

Referring now to FIGS. 9A and 9B, state diagrams 900 and 950 illustrating the operation of an illustrative base computer will be described. State diagram 900 begins at state 902, where RFID tag data is received at the base computer from the RFID interrogator. The state diagram 900 then moves to state 904, where data corresponding to the received RFID tag data is retrieved from the parking system database. The state diagram then moves to state 906, where the vehicle slot number is displayed. This information may be utilized by a parking attendant to retrieve the customers car. Additionally, a dispatcher may be notified by the base computer to dispatch a bus to retrieve the waiting customer. The state diagram then returns to state 902, where additional RFID tag data is received.

The state diagram 950 begins at state 908, where updated bus arrival data is received at the base computer. This data may be provided in an automated fashion or may be entered by hand into the base computer upon dispatch of a bus. The state diagram 950 then moves to state 910, where the bus arrival data is transmitted to the computer located at the airport. This information is then displayed by the computer for the customer's benefit. The routine 950 then returns to state 908, where further bus arrival data is received.

Referring now to FIG. 9C, additional aspects regarding the operation of the base computer according to an embodiment of the present invention will be described. As described briefly above, according to an embodiment of the present invention, the base computer is further equipped with a display mounted proximate to the entrance of the parking lot and an RFID interrogator also placed proximate to the entrance to the parking lot. State diagram 975 shown in FIG. 9C illustrates the further operation of the base computer in such an embodiment. State diagram 975 begins at state 912, where the area surrounding the entrance to the parking lot is interrogated for RFID tags. If an RFID tag is located, the state diagram 975 changes to state 914, where a determination is made as to whether the data decoded from the RFID tag is valid. If the data is not valid, the state returns to state 912. If the data is valid, the state continues to state 914.

At state 914, the parking system database is updated to include the information decoded from the RFID tag. In this manner, a customer who has been previously issued an RFID tag needs to take no actions when they return to the parking lot to ensure that the database correctly reflects that their vehicle has been parked in the lot. From state 916, the state diagram 975 continues to state 918, where the display located at the entrance to the parking lot is updated to display a confirmation to the customer that their RFID tag has been correctly decoded. The state diagram 975 then returns to state 912 where additional RFID tags are decoded. When the customer returns to the airport, their RFID tag is decoded at the terminal island and a courtesy bus is sent to retrieve them as described above.

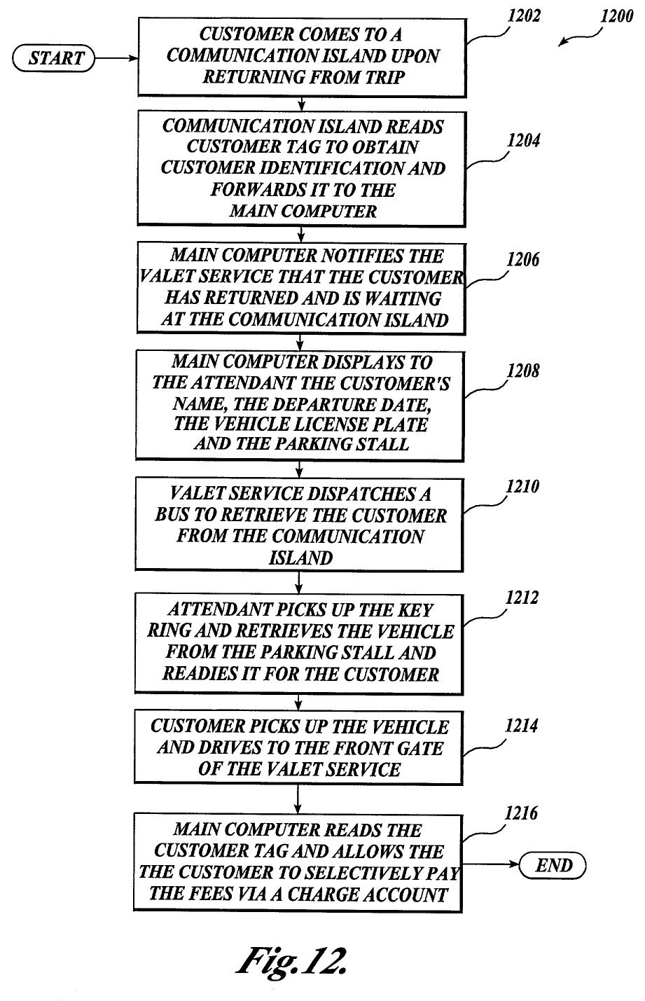

A process 1100 for receiving a vehicle 1008 from the customer 1006 by a valet parking service is illustrated in FIG. 11. The customer 1006 drives his vehicle 1008 to the lot of the valet parking service and parks his car in front of the attendant. The attendant receives the vehicle 1008 from the customer 1006 who then proceeds to commence his trip at block 1102. Other customers may similarly drop off their vehicles without having to fill out forms or wait for the attention of the attendant. As each customer 1006 is leaving the lot of the valet parking service, the main computer 1002 reads each customer tag 7 via short-range radio frequency communication to obtain the identity of the customer 1006. The main computer 1002 also forms an incomplete trip record for each customer 1006 and stores such information in the database 4 at block 1104.

At block 1106, the attendant uses the handheld computer 1004 to read the vehicle tag 1010 via short-range radio frequency communication. The vehicle tag 1010 contains information that identifies the vehicle 1008, such as the license plate number. After obtaining vehicle information, the attendant parks the vehicle 1008 at any parking stall, such as the parking stall 1012. Again using the handheld computer 1004, the attendant communicates with the stall tag 1014 to obtain the stall identifying information at block 1108. Optionally, the attendant can attach the key tag 1020 to the key ring 1016 and uses the handheld computer 1004 to read information identifying the key ring 1016 at block 1110.

After coming back from the parking stall 1012, the attendant, at block 1112, sets the handheld computer 1004 to download to the main computer 1002 various pieces of obtained information stored within the handheld computer 1004. The main computer 1002 then complete various trip records by adding to the identity of the customer the identity of the vehicle 1008, the received date (or the date on which the customer left the car in the care of the valet parking service to embark upon his trip), and the identity of the parking stall 1012 in which the vehicle 1008 is parked.

If the key ring needs to be stored in an envelope or other similar containers, the main computer, at block 1116, may optionally print out a label that identifies the customer, the vehicle, and the parking stall. The label can be attached to the envelope containing the key ring 1016. The label allows the attendant to quickly identify the key 1018 to start the vehicle 1008.

A process 1200 for retrieving a vehicle 1008 for the customer 1006 by a valet parking service is illustrated in FIG. 12. The customer 1006 comes to the communication island 17, at block 1202, upon returning from the trip. The communication island 17 reads the customer tag to obtain customer identification and forwards the information to the main computer 1002 at block 1204. The process proceeds to block 1206 where the main computer 1002 notifies the valet service that the customer has returned and is waiting at the communication island 17. The main computer 1002 also displays to the attendant the customer's name, departure date, vehicle license plate, and the parking stall in which the vehicle 1008 is parked at block 1208.

The valet service, at block 1210, promptly dispatches a bus or other retrieving vehicle to retrieve the customer 1006 from the communication island 17. In the meantime, the attendant picks up the key ring 1016, retrieves the vehicle 1008 from the parking stall 1012, and readies it for the customer's use at block 1212. When the customer returns to the valet service, he can pick up his vehicle 1008 and drive to the front gate at block 1214. The main computer 1002 reads via short-range radio frequency communication the customer tag and displays the parking fees to the customer 1006. The customer 1006 can choose to pay by cash or have the main computer 1002 automatically charge a charge account at block 1216. In another embodiment, the customer 1006 walks to the point-of-sale counter and uses a biometric device to allow the main computer 1002 to identify the customer 1006. After identification, the customer 1006 makes payment for parking services, gets in his vehicle 1008, and drives away.

In light of the above, it should be appreciated that the present invention provides an improved airport parking communication system. While an actual embodiment of the invention has been illustrated and described, it will be appreciated that various changes can be made therein without departing from the spirit and scope of the invention.

The embodiments of the invention in which an exclusive property or privilege is claimed are defined as follows:

1. A valet communication system, comprising:
a vehicle tag fitted to a vehicle and adapted for identifying the vehicle via radio frequency communication;
a stall tag fitted to a parking stall and adapted for identifying the parking stall via radio frequency communication; and
a handheld computer adapted for communicating with the vehicle tag via radio frequency communication to obtain an identification of the vehicle and for communicating with the stall tag via radio frequency communication to obtain an identification of the parking stall so as to correlate the vehicle and the parking stall in which the vehicle is parked.

2. The system of claim 1, further comprising a key tag fitted to a key ring of the vehicle and adapted for identifying the key ring of the vehicle via radio frequency communication, the handheld computer being able to communicate with the key tag via radio frequency communication so as to correlate the vehicle with the key ring that holds a key to start the vehicle.

3. The system of claim 2, further comprising a customer tag held by a customer and adapted for identifying the customer via radio frequency communication.

4. The system of claim 3, further comprising a main computer having a database to store an identification of the customer obtained via radio frequency communication between the main computer and the customer tag, the main computer being adapted to communicate with the handheld computer to obtain the identification of the vehicle, the parking stall, and the key ring.

5. The system of claim 4, further comprising a communication island located near the airport for communicating via radio frequency with the customer tag of the customer to obtain an identification of the customer so that the identification of the customer may be sent to the database for correlating the customer with the vehicle, the parking stall, and the key ring.

6. The system of claim 5, further comprising a dispatching subsystem for dispatching a retrieving vehicle to retrieve the customer at the communication island and for dispatching an attendant to retrieve the vehicle which is parked at the parking stall so as to ready the vehicle for the customer to use.

7. The system of claim 6, further comprising a payment subsystem for communicating via radio frequency with the customer tag to calculate incurred fees associated with using the parking stall and to selectively charge the incurred fees to an account of the customer.

8. A method for communicating valet parking information, comprising:
reading via short-range radio frequency a vehicle tag fitted to a vehicle to obtain an identification of the vehicle, the act of reading being executed by an attendant using a handheld computer upon receiving the vehicle from a customer;
acquiring via short-range radio frequency a stall tag fitted to a parking stall in which the vehicle is parked to obtain an identification of the parking stall, the act of acquiring being executed by the attendant using the handheld computer upon parking the vehicle in the parking stall; and
loading to a database on a main computer the identification of the vehicle and the parking stall so that the database may correlate the vehicle with the parking stall.

9. The method of claim 8, wherein the act of reading reads a key tag fitted on a key ring to obtain an identification of a key ring that holds a key to start the vehicle.

10. The method of claim 9, further comprising printing a label for attaching to an envelope that is adapted to contain the key ring, the label including the identification of the vehicle, the key ring, and the parking stall.

11. The method of claim 10, further comprising forming a trip record by the database, the trip record including information related to the customer, the vehicle of the customer, a date on which the attendant received the vehicle, and the parking stall in which the vehicle was parked.

12. The method of claim 11, further comprising sensing via short-range radio frequency a customer tag of the customer who is returning from a trip when the customer tag is within proximity to a communication island, the act of sensing obtaining an identification of the customer and forwarding the identification of the customer to the main computer.

13. The method of claim 12, further comprising displaying to the attendant on a display the identification of the customer, the date on which the attendant received the vehicle, a license number on a license plate of the vehicle, and the identification of the parking stall, the act of displaying being executed when the act of sensing obtains the identification of the customer.

14. The method of claim 13, further comprising retrieving the customer from the communication island by dispatching a retrieving vehicle, the act of retrieving including retrieving the vehicle by the attendant to ready the vehicle for use.

15. The method of claim 14, further comprising paying fees associated with the valet parking, the act of paying including communicating via short-range radio frequency with the customer tag to obtain the identification of the customer such that a charge account associated with the identification of the customer may be charged with the fees.
